(19) United States
(12) Patent Application Publication
(10) Pub. No.: US 2004/0125879 A1
(43) Pub. Date: Jul. 1, 2004

(54) Information transmission unit

(76) Inventors: James E. Jaussi, Hillsboro, OR (US); Bryan K. Casper, Hillsboro, OR (US); David J. Comer, Springville, UT (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/335,194

(22) Filed: Dec. 31, 2002

(51) Int. Cl. H04L 27/00

(52) U.S. Cl. 375/259

(57) ABSTRACT

An information transmission unit includes a signal source, a channel having a channel cutoff frequency coupled to the signal source, a continuous-time linear active filter coupled to the channel to provide equalization over a range of frequencies, and a sampling unit coupled to the continuous-time linear active filter. A method includes transmitting a continuous time signal including digital information on a channel, receiving the continuous time signal from the channel and filtering the continuous time signal to form an equalized continuous time signal, and sampling the equalized continuous time signal to recover the digital information.

### FIELD

This invention relates to information transmission and, more particularly, to high speed information transmission systems.

### BACKGROUND

Consumers demand systems (such audio systems, and real time video systems) that require transmission of information at high data rates. Data rates can be increased in a system by improving the performance (i.e., bandwidth) of transmitter and receiver components in the system. However, high data rate systems are subject to distortion, which increases the error rate in the system, introduced by the channel (such as free space or transmission lines) over which information is transmitted. Intersymbol interference (i.e., temporal spreading of information units within a signal) is one type of distortion that increases the error rate in high data rate systems. Unfortunately, improving the performance of transmitter and receiver components does not reduce data errors, such as data errors introduced by intersymbol interference, in high data rate systems.

### BRIEF DESCRIPTION OF THE DRAWINGS

FIG. 1 shows a block diagram of an information transmission unit including a signal source, a channel, a filter, and a sampling unit in accordance with an embodiment of the invention.

FIG. 2A shows a schematic diagram of the signal source shown in FIG. 1 including a single-ended driver in accordance with another embodiment of the invention.

FIG. 2B shows a schematic diagram of the signal source shown in FIG. 1 including a differential driver in accordance with another embodiment of the invention.

FIG. 3A shows a top view of the channel shown in FIG. 1 in accordance with another embodiment of the invention.

FIG. 3B shows a cross-sectional side view of the channel shown in FIG. 3A taken along the line Y-Y.

FIG. 3C shows a top view of the channel shown in FIG. 1 in accordance with another embodiment of the invention.

FIG. 3D shows a cross-sectional side view of the channel shown in FIG. 3C taken along the line Z-Z.

FIG. 4A shows a magnitude-versus-frequency graph of a channel transfer function for the channel shown in FIG. 1.

FIG. 4B shows a magnitude-versus-frequency graph of a filter transfer function for the filter shown in FIG. 1.

FIG. 4C shows a magnitude-versus-frequency graph of a combination transfer function for the channel transfer function shown in FIG. 4A and the filter transfer function shown in FIG. 4B.

FIG. 5A shows a schematic diagram of the filter shown in FIG. 1 including a four-input differential amplifier in accordance with another embodiment of the invention.

FIG. 5B shows a schematic diagram of the filter shown in FIG. 1 including a buffer unit and an active filter in accordance with another embodiment of the invention.

FIG. 5C shows a schematic diagram of the filter shown in FIG. 1 including a single-ended non-inventing amplifier in accordance with another embodiment of the invention.

FIG. 5D shows a schematic diagram of the four-input differential amplifier shown in FIG. 5A in accordance with another embodiment of the invention.

FIG. 6 shows a schematic diagram of the sampling unit shown in FIG. 1 in accordance with another embodiment of the invention.

FIG. 7 shows a block diagram of a channel coupling a signal source, formed on a substrate, to a filter, a sampling unit, and a processor formed on a substrate in accordance with another embodiment of the invention.

FIG. 8 shows a flow diagram of a method for transmitting information in accordance with another embodiment of the invention.

FIG. 9 shows a schematic diagram of the differential amplifier shown in FIG. 5B in accordance with another embodiment of the invention.

### DESCRIPTION

In the following detailed description of some embodiments of the invention, reference is made to the accompanying drawings which form a part hereof, and in which are shown, by way of illustration, specific embodiments of the invention which may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is not to be taken in a limiting sense, and the scope of the present invention is defined only by the appended claims, along with the full scope of equivalents to which such claims are entitled.

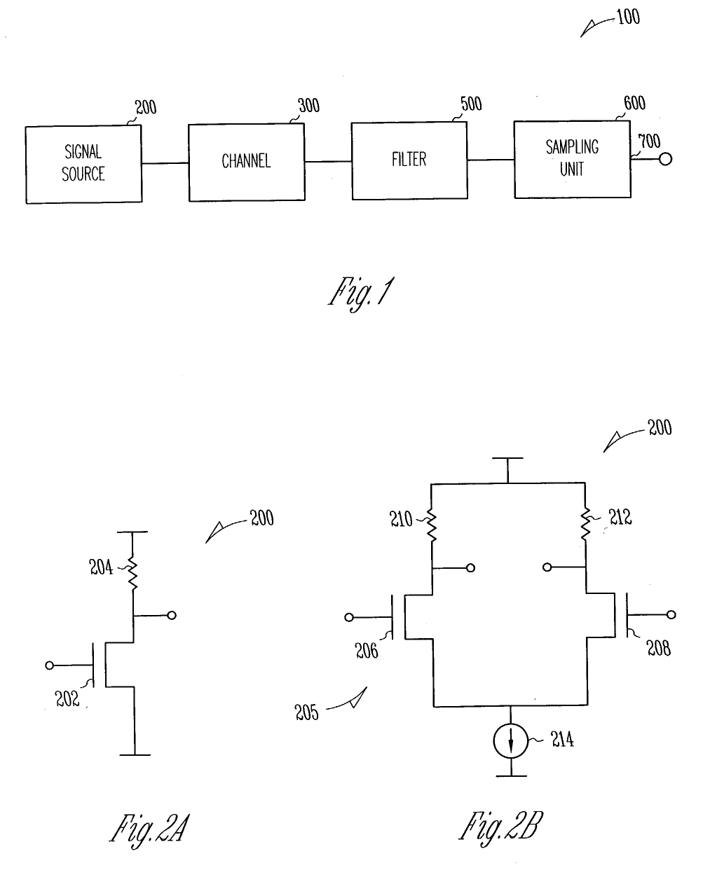

FIG. 1 shows a block diagram of an information transmission unit 100 including a signal source 200, a channel 300, a filter 500, and a sampling unit 600 in accordance with an embodiment of the invention. The signal source 200 is coupled to the channel 300. The channel 300 is coupled to the filter 500. The filter 500 is coupled to the sampling unit 600. The sampling unit 600 includes an output port 700. Two elements are coupled if one element can receive information from the other element. For example, a transistor driver that is electrically connected to a transmission line is coupled to the transmission line. In another example, an antenna is coupled to free-space.

In operation, the signal source 200 provides a continuous time signal including information, such as digitally encoded information, to the channel 300. The channel 300 provides a signal path from the signal source 200 to the filter 500. The filter 500 equalizes the continuous time signal received from the channel. The sampling unit 600 samples the signal to generate a sampled signal for use in recovering the information contained in the continuous time signal. The sampling unit 600 provides the sampled signal at the output port 700.

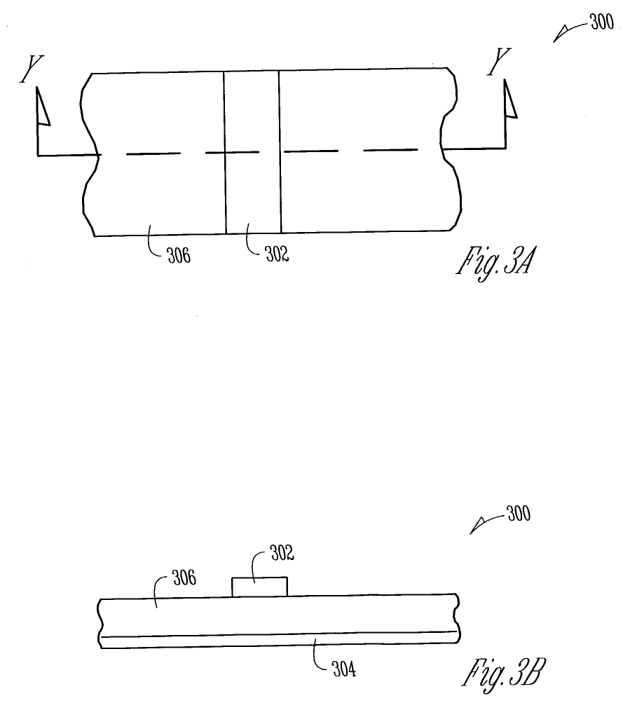

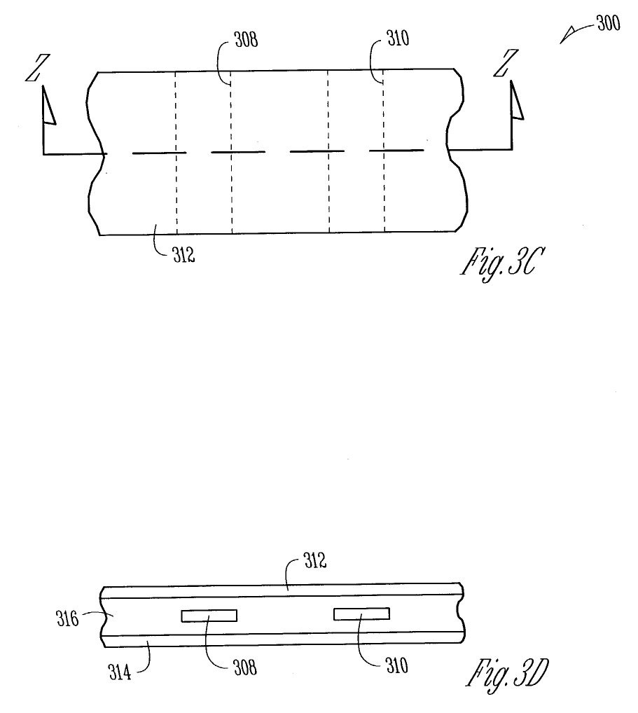

FIG. 2A shows a schematic diagram of the signal source 200 shown in FIG. 1 in accordance with another embodiment of the invention. The signal source 200 shown in FIG. 2A includes an insulated gate field-effect transistor 202 and a resistor 204 configured as a single-ended driver. A single-ended driver is suitable for use in driving the channel 300 (shown in FIG. 1) where the channel 300 is a transmission line, such as a microstrip transmission line (shown in FIGS. 3A and 3B and described below). However, the signal source 200, is not limited to the single-ended driver configuration shown in FIG. 2A.

FIG. 2B shows a schematic diagram of a signal source 200 shown in FIG. 1 in accordance with another embodiment of the invention. The signal source 200 shown in FIG. 2B includes a differential pair 205 including a pair of insulated gate field-effect transistors 206 and 208, resistors 210 and 212, and a current source 214 configured as a differential driver. A differential driver is suitable for use in driving the channel 300 (shown in FIG. 1) where the channel 300 is a transmission line, such as a pair of stripline transmission lines (shown in FIGS. 3C and 3D and described below).

Neither the signal source 200 shown in FIG. 2A nor the signal source 200 shown in FIG. 2B is limited to operation at a particular data rate or frequency. In some embodiments, the signal source 200 operates at a data rate of between about one gigahertz (one billion bits per second) and about five gigahertz. High data rate systems include signals operating at these frequencies and above. Although the signal source 200 shown in each of the FIGS. 2A and 2B is a voltage source, the signal source 200 is not limited to voltage sources. Current sources are also suitable for use in connection with the information transmission unit 100 (shown in FIG. 1).

FIG. 3A shows a top view of the channel 300 shown in FIG. 1 in accordance with another embodiment of the invention. The channel 300 shown in FIG. 3A is a microstrip transmission line. The microstrip transmission line shown in FIG. 3A includes a conductive strip 302 separated from a conductive plane 304 (not shown in FIG. 3A, shown in FIG. 3B) by a dielectric 306. FIG. 3B shows a cross-sectional side view of the channel 300 shown in FIG. 3A taken along the line Y-Y. As can be seen in FIG. 3B, the conductive strip 302 is aligned substantially parallel with the conductive plane 304.

FIG. 3C shows a top view of the channel 300 shown in FIG. 1 in accordance with another embodiment of the invention. The channel 300 shown in FIG. 3C is a stripline transmission line. The stripline transmission line shown in FIG. 3C includes conductive strips 308 and 310 separated from conductive planes 312 and 314 (not shown in FIG. 3C, shown in FIG. 3D) by a dielectric 316 (not shown in FIG. 3C, shown in FIG. 3D). FIG. 3D shows a cross-sectional side view of the channel 300 shown in FIG. 3C taken along the line Z-Z. The conductive strips 308 and 310 are embedded in the dielectric 316 and located between the conductive planes 312 and 314. As can be seen in FIG. 3D, the conductive strips 308 and 310 are aligned substantially parallel with the conductive planes 312 and 314.

Materials suitable for use in the fabrication of the conductive strip 302 and the conductive plane 304 shown in FIGS. 3A and 3B and the conductive strips 308 and 310 and the conductive planes 312 and 314 shown in FIGS. 3C and 3D include conductive materials, such as gold, copper, aluminum, silver, and polysilicon. Dielectric materials suitable for use in the fabrication of the dielectric 306 shown in FIGS. 3A and 3B and dielectric 316 shown in FIG. 3D include FR4, oxides, nitrides, and polymers.

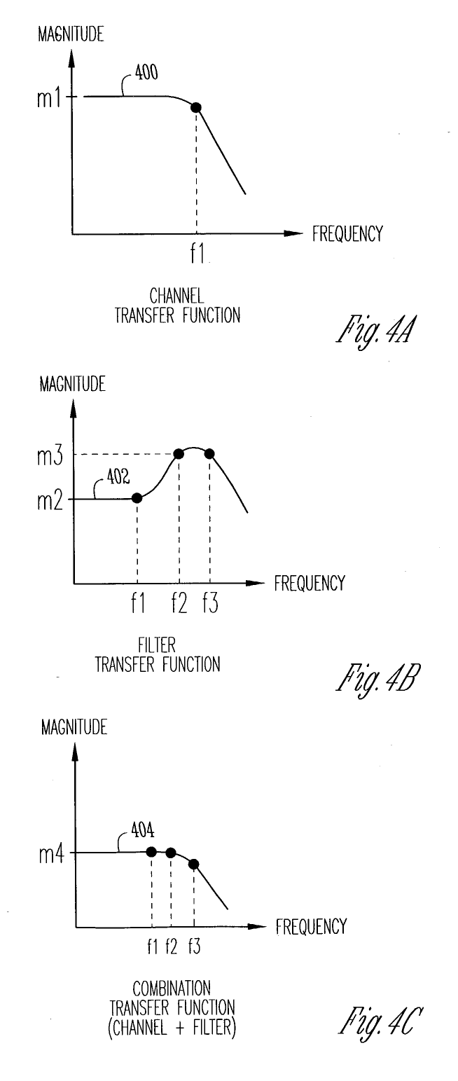

FIG. 4A shows a magnitude-versus-frequency graph of a channel transfer function 400 for the channel 300 shown in FIG. 1. The channel transfer function 400 approximates a low-pass filter transfer function. The channel transfer function 400 is substantially flat with a magnitude m1 for low frequencies and decreases for frequencies greater than the channel cutoff frequency f1. The term “cutoff frequency” is not limited in meaning to a “roll-off” frequency. The term is also intended to denote a break-point frequency (a frequency at which the magnitude of a transfer function changes).

FIG. 4B shows a magnitude-versus-frequency graph of a filter transfer function 402 for the filter 500 shown in FIG. 1. The filter transfer function 402 is substantially flat with a magnitude m2 for low frequencies. The magnitude increases for frequencies greater than the channel cutoff frequency f1 up to a frequency f2. The magnitude is substantially flat at a magnitude m3 up to a frequency f3. The magnitude decreases for frequencies greater than f3.

The frequencies f2 and f3 are characteristic of the filter 500. In some embodiments, f2 is determined by a pole of the amplifier included in the filter 500. In some embodiments, f2 is determined by passive components external to the amplifier included in the filter 500. The frequency f3 is determined by a pole in the amplifier included in the filter 500.

FIG. 4C shows a magnitude-versus-frequency graph of a combination transfer function 404 for the channel transfer function 400 shown in FIG. 4A and the filter transfer function 402 shown in FIG. 4B. The combination transfer function 404 approximates a low-pass filter transfer function. The combination transfer function 404 is substantially flat with a magnitude m2 for frequencies less than the frequency f2. For frequencies greater than the frequency f2 the combination transfer function 404 decreases. Thus, the frequency f2 is the cutoff frequency for the combination transfer function 404. The cutoff frequency f2 is greater than the cutoff frequency f1, so the bandwidth of the combination transfer function 404 is greater than the bandwidth of the channel transfer function 400 shown in FIG. 4A. The frequency f3 is located at a higher frequency than the frequency f2. The frequency f2 is a high order pole frequency of the active devices used to implement the filter transfer function 402. The magnitude m2 of the filter transfer function 402 (shown in FIG. 4B) is selected to equalize the magnitude of signals at frequencies less than the frequency f1 and signals at frequencies between the frequencies f1 and f2 to a magnitude m4 after the signals pass through the channel 300 (shown in FIG. 1) and the filter 500 (shown in FIG. 1).

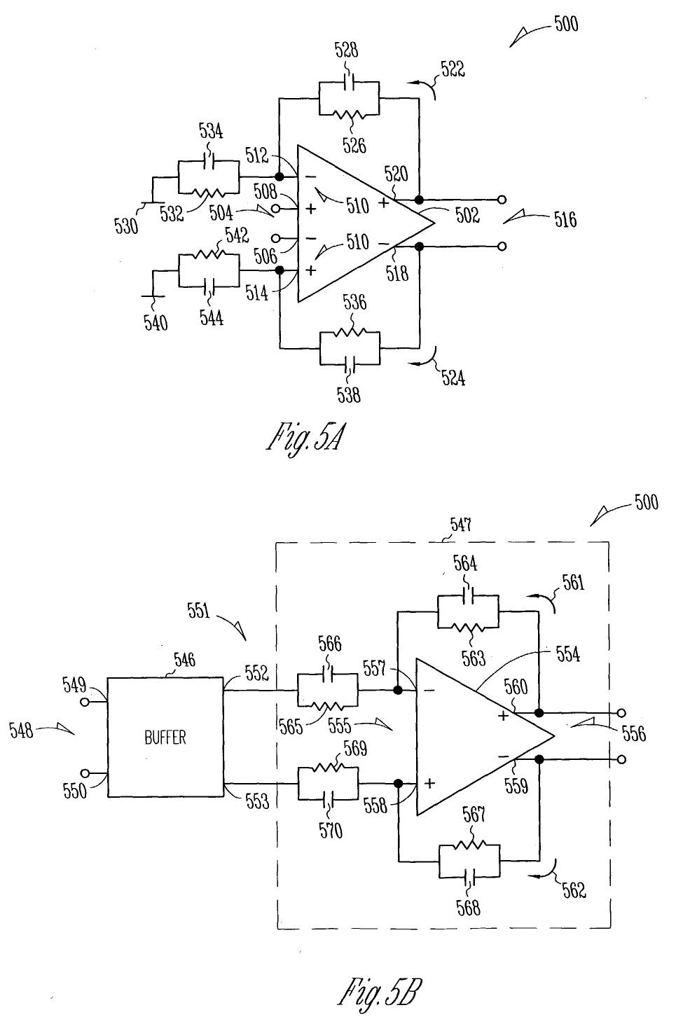

FIG. 5A shows a schematic diagram of the filter 500 shown in FIG. 1 including a four-input differential amplifier 502 in accordance with another embodiment of the invention. The filter 500 has an input port 504 including an inverting input terminal 506 and a non-inverting input terminal 508, an input port 510 including an inverting input terminal 512 and a non-inverting input terminal 514, and an output port 516 including an inverting output terminal 518 and a non-inverting output terminal 520.

The filter 500 includes feedback paths 522 and 524. The feedback path 522 couples the non-inverting output terminal 520 to the inverting input terminal 512 through the parallel connection of a resistor 526 and the a capacitor 528. The inverting input terminal 512 is coupled to a node 530 through the parallel connection of a resistor 532 and a capacitor 534. The feedback path 524 couples the inverting output terminal 518 to the non-inverting input terminal 514 through the parallel connection of a resistor 536 and a capacitor 538. The non-inverting input terminal 514 is coupled to a node 540 through the parallel connection of a resistor 542 and a capacitor 544.

The resistors 526, 532, 536, and 542 and the capacitors 528, 534, 538, and 544 are selected to provide a transfer function for the filter 500 substantially equivalent to the filter transfer function 402 (shown in FIG. 4B). The resistor 532 and the capacitor 534 and the resistor 542 and the capacitor 544 are selected to provide the cutoff frequency f1 (shown in FIG. 4B). The resistor 526 and the capacitor 528 and the resistor 536 and the capacitor 538 are selected to provide the cutoff frequency f2 (shown in FIG. 4B).

In some embodiments, the capacitors 528 and 538 are removed from the filter 500, and the resistors 526 and 536 selected, in light of the frequency response and knowledge of the dominant pole location in the four-input differential amplifier 502, to provide the cutoff frequency f2.

The four-input differential amplifier 502 is configured as a non-inverting amplifier having infinite input resistance at the input port 504. An exemplary four-input differential amplifier 502 suitable for use in connection with the filter 500 is shown in FIG. 5D and described below. The four-input differential amplifier 502 has one dominant pole, so the differential amplifier 502 requires no additional compensation for stability. In addition, the four-input differential amplifier 502 has a relatively low gain, so the differential amplifier 502 does not require a common-mode feedback circuit for the fully differential gain stage.

In operation, the filter 500 is coupled unbuffered to the channel 300 (shown in FIG. 1) and functions as a continuous time linear active filter that equalizes signals over a range of frequencies. A continuous time filter is a filter that processes continuous time signals rather than discrete time signals, such as signals processed by a digital signal processor. Continuous time signals include digital signals that are not sampled. A linear filter is a filter that scales voltage and current signals linearly. An active filter is a filter that can add energy to a signal, such as required for increasing the magnitude of high frequency signals. The term “node” denotes a negative, zero, positive, or variable potential.

FIG. 5B shows a schematic diagram of the filter 500 shown in FIG. 1 including a buffer unit 546 and an active filter 547 in accordance with another embodiment of the invention. The buffer unit 546 includes an input port 548 including input terminals 549 and 550 and an output port 551 including output terminals 552 and 553. The buffer unit 546 is selected to have a substantially infinite input resistance at each of the input terminals 549 and 550 and a substantially zero output resistance at the output terminals 552 and 553. In operation, the buffer unit 546 prevents the active filter 547 from loading the signal source 200 (shown in FIG. 1) and transmits a signal (not shown) at the input port 548 to the output port 551. In some embodiments, the buffer unit 546 provides a level shifted signal at the output port 551. In some embodiments, the active filter 547 is coupled directly to the channel 300 (shown in FIG. 1) without a buffer.

The active filter 547 includes a differential amplifier 554 configured as an inverting amplifier that has an input port 555 and an output port 556. The input port 555 includes an inverting input terminal 557 and a non-inverting input terminal 558. In some embodiments, the input port 555 of the differential amplifier 554 includes n-type insulated gate field-effect transistors. The n-type insulated gate field-effect transistors provide improved high frequency performance when compared with p-type insulated gate field-effect transistors and thus provide a reduction of intersymbol interference. The output port 556 includes an inverting output terminal 559 and a non-inverting output terminal 560. The active filter 547 includes feedback paths 561 and 562. The feedback path 561 includes the parallel connection of a resistor 563 and a capacitor 564 that couples the non-inverting output terminal 560 to the inverting input terminal 557. The parallel connection of a resistor 565 and a capacitor 566 couples the output terminal 552 of the buffer unit 546 to the inverting input terminal 557 of the differential amplifier 554. The feedback path 562 includes the parallel connection of a resistor 567 and a capacitor 568 that couples the inverting output terminal 559 to the non-inverting input terminal 558. The parallel connection of a resistor 569 and a capacitor 570 couples the output terminal 553 of the buffer unit 546 to the non-inverting input terminal 558 of the differential amplifier 554.

The resistors 563, 565, 567, and 569 and the capacitors 564, 566, 568, and 570 are selected to provide a transfer function for the filter 500 substantially equivalent to the filter transfer function 402 (shown in FIG. 4B). The resistor 565 and the capacitor 566 and the resistor 569 and the capacitor 570 are selected to provide the cutoff frequency f1 (shown in FIG. 4B). The resistor 563 and the capacitor 564 and the resistor 567 and the capacitor 568 are selected to provide the cutoff frequency f2 (shown in FIG. 4B).

In operation, the filter 500 functions as a continuous time linear active filter that equalizes signals over a range of frequencies.

FIG. 5C shows a schematic diagram of the filter 500 shown in FIG. 1 including a differential amplifier 571 configured as a single-ended non-inverting amplifier in accordance with another embodiment of the invention. The differential amplifier 571 has a differential input port 572, a single-ended input port 573, and an output port 574. The differential input port 572 includes an inverting input terminal 575 and a non-inverting input terminal 576. The single-ended input port 573 includes the non-inverting input terminal 576 referenced to a node 577. The output port 574 includes a non-inverting output terminal 578 referenced to a node 579. A feedback path 582 includes the parallel connection of a resistor 584 and a capacitor 585 that couples the non-inverting output terminal 578 to the inverting input terminal 575. The parallel connection of a resistor 586 and a capacitor 587 couples the inverting input terminal 575 to a node 588.

The resistors 584 and 586 and the capacitors 585 and 587 are selected to provide a transfer function for the filter 500 substantially equivalent to the filter transfer function 402 (shown in FIG. 4B). The resistor 586 and the capacitor 587 are selected to provide the cutoff frequency f1 (shown in FIG. 4B). The resistor 584 and the capacitor 585 are selected to provide the cutoff frequency f2 (shown in FIG. 4B).

In operation, the filter 500 has a substantially infinite input resistance at the non-inverting input terminal 576 and a substantially zero output resistance at the non-inverting output terminal 578.

Each of the amplifiers, including the four-input differential amplifier 502 shown in FIG. 5A, the differential amplifier 554 shown in FIG. 5B, and the differential amplifier 571 shown in FIG. 5C, includes a single stage amplifier having one dominant pole. Thus, the bandwidth of the filter 500 shown in FIGS. 5A, 5B, and 5C is not limited by the bandwidth of the amplifier, and the filter 500 can have a wide bandwidth.

FIG. 5D shows a schematic diagram of the four-input differential amplifier 502 shown in FIG. 5A in accordance with another embodiment of the invention. The four-input differential amplifier 502 has an input port 504 including an inverting input terminal 506 and a non-inverting input terminal 508, an input port 510 including an inverting input terminal 512 and a non-inverting input terminal 514, and an output port 516 including an inverting output terminal 518 and a non-inverting output terminal 520. The four-input differential amplifier 502 includes differential pairs 589 and 590 connected in parallel and coupled to a current mirror 591. The differential pair 589 includes insulated gate field-effect transistors 592 and 593 connected in parallel between a current source 594 and the current mirror 591. The insulated gate field effect transistor 592 includes the inverting input terminal 506. The insulated gate field effect transistor 593 includes the non-inverting input terminal 514.

The differential pair 590 includes insulated gate field-effect transistors 595 and 596 connected in parallel between a current source 597 and the current mirror 591. The insulated gate field effect transistor 595 includes the inverting input terminal 512. The insulated gate field effect transistor 596 includes the non-inverting input terminal 508.

In operation, the differential pair 589 controls the current flow at the inverting output terminal 518 and the differential pair 590 controls the current flow at the non-inverting output terminal 520. The differential pairs 589 and 590 provide a four-input differential amplifier having only one dominant pole.

The differential pairs 589 and 590 are not limited to being operated as a pair. Either of the differential pairs 589 or 590 is suitable for use as the differential amplifiers 554 (shown in FIG. 5B) or 571 (shown in FIG. 5C) in connection with the filter 500. In some embodiments, the differential pairs 589 and 590 have a single-pole transfer function. In some embodiments, the insulated gate field-effect transistors 592, 593, 595, and 596 are p-type insulated gate field-effect transistors.

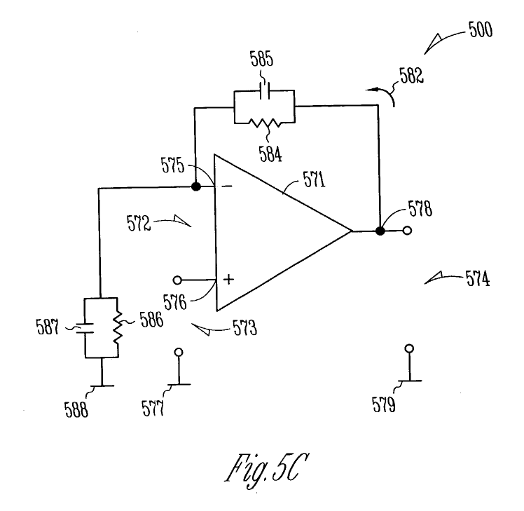

FIG. 6 shows a schematic diagram of the sampling unit 600 shown in FIG. 1 in accordance with another embodiment of the invention. The sampling unit 600 includes at least one energy storage device. The sampling unit 600 includes an input terminal 602, an insulated gate field-effect transistor 604, a capacitor 606, a node 608, and an output port 700. The insulated gate field-effect transistor 604 includes a control terminal 612. The capacitor 606 is not limited to a particular type of capacitor. Poly-poly capacitors, metal capacitors, and trench capacitors are suitable for use in connection with the sampling unit 600. Poly-poly capacitors include two or more layers of polysilicon. Metal capacitors include metal-oxide-metal or metal-oxide/nitride/oxide-metal structures. Trench capacitors include polysilicon-oxide-silicon structures formed in a trench. In operation, the insulated gate field-effect transistor 604 functions as a switch to gate a signal at the input terminal 602 to the capacitor 606. A control signal at the control terminal 612 enables and disables the transmission of the signal at the input terminal 602 to the capacitor 606 and the output port 700.

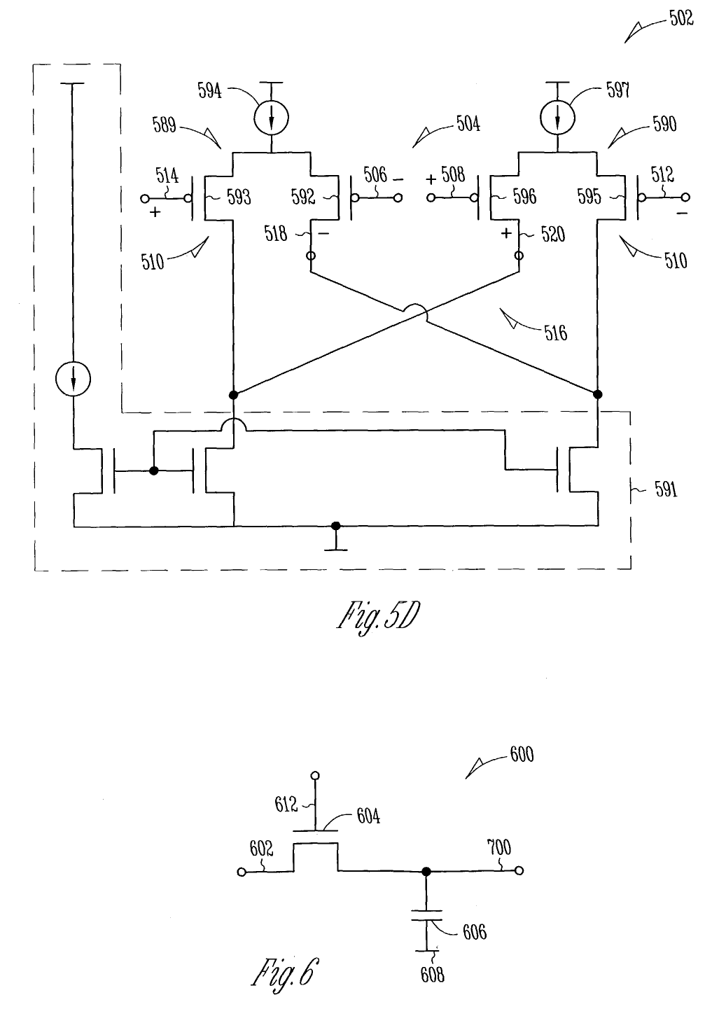

FIG. 7 shows a block diagram of a channel 300 coupling a signal source 200 formed on a substrate 700 to a filter 500, a sampling unit 600, and a processor 702 formed on a substrate 704 in accordance with another embodiment of the invention. On the substrate 704, the sampling unit 600 is coupled to the filter 500 and the processor 702. In some embodiments, the channel 300 includes an FR-4 substrate. In some embodiments, the substrate 700 is formed from gallium arsenide and the substrate 704 is formed from silicon.

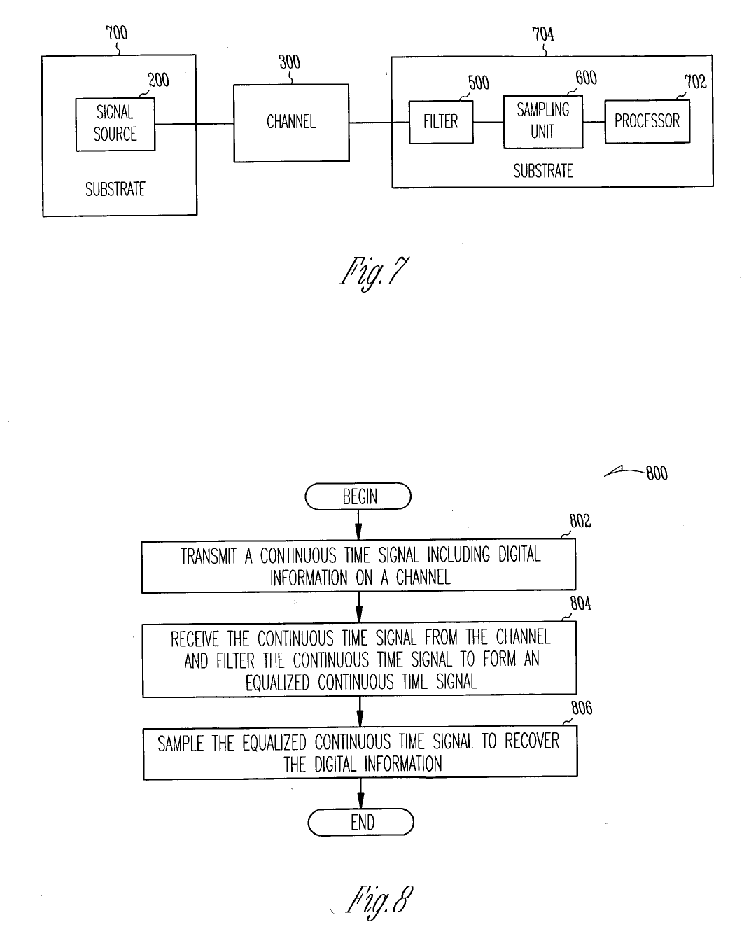

FIG. 8 shows a flow diagram of a method 800 for transmitting information in accordance with another embodiment of the invention. The method 800 includes transmitting a continuous time signal including digital information on a channel (block 802), receiving the continuous time signal from the channel and filtering the continuous time signal to form an equalized continuous time signal (block 804), and sampling the equalized continuous time signal to recover the digital information (block 806). In some embodiments, transmitting the continuous time signal includes transmitting the continuous time signal at a data rate of at least one billion bits per second. In some embodiments, receiving the continuous time signal from the channel includes receiving the continuous time signal at a buffer.

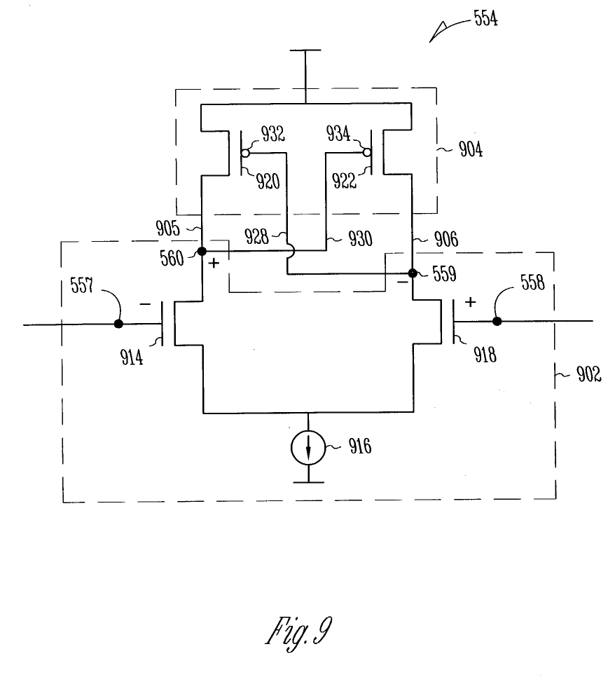

FIG. 9 shows a schematic diagram of the differential amplifier 554 shown in FIG. 5B in accordance with another embodiment of the invention. The differential amplifier 554 includes a differential pair 902 and a nonlinear load 904 coupled to the differential pair 902 through interconnects 905 and 906. The differential pair 902 includes an inverting input terminal 557 and a non-inverting input terminal 558 and an inverting output terminal 559 and a non-inverting output terminal 560.

The inverting output terminal 559 and the non-inverting output terminal 560 are cross-coupled to the nonlinear load 904 to provide positive feedback in the differential amplifier 554. The use of positive feedback can cause an amplifier to become unstable, but setting the direct-current gain of the differential amplifier 554 to less than one stabilizes the differential amplifier 554. The use of positive feedback increases the gain-bandwidth product of the differential amplifier 554. Increasing the gain-bandwidth product of the differential amplifier 554 makes the differential amplifier 554 suitable for use in connection with applications that require processing of fast rise time signals, such as the signals encountered in digital signaling applications. Digital signaling applications include sending and receiving of digital signals on a single die and among dice in a digital or mixed signal system.

In use, such as in the filter 500 (shown in FIG. 5B), to provide negative feedback in the differential amplifier 554, the inverting output terminal 559 is coupled through an impedance (such as the parallel connection of the resistor 567 and the capacitor 568 as shown in FIG. 5B) to the non-inverting input terminal 558, and the non-inverting output terminal 560 is coupled through an impedance (such as the parallel connection of the resistor 563 and the capacitor 564 as shown in FIG. 5B) to the inverting output terminal 557. The use of negative feedback reduces the sensitivity of the differential amplifier 554 to open loop gain variations.

The differential pair 902 includes a first insulated gate field-effect transistor 914 coupled to a current source 916 and a second insulated gate field-effect transistor 918 coupled to the current source 916. In operation, the differential pair 902 receives a signal (such as a voltage signal from a voltage source in series with an impedance) at the inverting input terminal 557 and the non-inverting input terminal 558 and divides the current provided by the current source 916 between the first insulated gate field-effect transistor 914 and the second insulated gate field-effect transistor 918. Thus, the output signal at the inverting output terminal 559 and the non-inverting output terminal 560 depends only on the difference between the input signals at the inverting input terminal 557 and the non-inverting input terminal 558. The nonlinear load 904 includes a pair of insulated gate field-effect transistors 920 and 922. The pair of insulated gate field-effect transistors 920 and 922 receives a feedback signal from the inverting output terminal 559 and the non-inverting output terminal 560 and delivers positive feedback through impedances (not shown in FIG. 9) to the inverting input terminal 557 and the non-inverting input terminal 558. The positive feedback, as noted above, improves the gain-bandwidth product of the differential amplifier 554.

The transistors used in the fabrication of the differential amplifier 554 are not limited to transistors of a single conductivity type. For example, in one embodiment, the first insulated gate field-effect transistor 914 and the second insulated gate field-effect transistor 918 are formed from materials including a first conductivity type, and the pair of insulated gate field-effect transistors 920 and 922 are formed from materials including a second conductivity type that is different from the first conductivity type. For example, in one embodiment, the first conductivity type is n-type and the second conductivity type is p-type. Thus, the first insulated gate field-effect transistor 914 and the second insulated gate field-effect transistor 918 are formed from materials having n-type conductivity, and the pair of insulated gate field-effect transistors 920 and 922 are formed from materials having p-type conductivity. Materials having n-type conductivity are formed by the addition of dopants to a host material where the dopants have a valency one more than the host atom. For example, n-type silicon is formed by adding elements such as arsenic, phosphorus, or antimony to silicon. Materials having p-type conductivity are formed by the addition of dopants to a host material where the dopants have a valency of one less than the host atom. For example, p-type silicon is formed by adding elements such as boron, aluminum, gallium, or indium to silicon.

In another embodiment, the inverting output terminal 559 and the non-inverting output terminal 560 are each coupled through an interconnect 928 or 930 having substantially zero resistance to a gate 932 or 934 of one of the pair of insulated gate field-effect transistors 920 and 922 of the nonlinear load 904. Substantially zero resistance can be obtained from a variety of interconnect materials. Exemplary materials suitable for use in connection with the fabrication of the interconnects 928 and 930 include aluminum, alloys of aluminum, copper, alloys of copper, and polysilicon.

Although specific embodiments have been described and illustrated herein, it will be appreciated by those skilled in the art, having the benefit of the present disclosure, that any arrangement which is intended to achieve the same purpose may be substituted for a specific embodiment shown. This application is intended to cover any adaptations or variations of the present invention. Therefore, it is intended that this invention be limited only by the claims and the equivalents thereof.

What is claimed is:

1. An information transmission unit comprising:
a signal source;
a channel coupled to the signal source, the channel having a channel cutoff frequency;
a continuous-time linear active filter coupled to the channel to provide equalization over a range of frequencies; and
a sampling unit coupled to the continuous-time linear active filter.

2. The information transmission unit of claim 1, wherein the continuous-time linear active filter comprises a four-input non-inverting differential amplifier.

3. The information transmission unit of claim 2, wherein the four-input non-inverting differential amplifier includes only one dominant pole.

4. The information transmission unit of claim 3, wherein the four-input non-inverting differential amplifier is coupled unbuffered to the channel.

5. The information transmission unit of claim 4, wherein the signal source generates a digital signal having a data rate of between about one gigahertz and about five gigahertz.

6. The information transmission unit of claim 1, wherein the signal source is formed on a first substrate and the continuous-time linear active filter is formed on a second substrate.

7. The information transmission unit of claim 6, wherein the first substrate comprises gallium arsenide and the second substrate comprises silicon.

8. The information transmission unit of claim 7, wherein the second substrate comprises a processor.

9. The information transmission unit of claim 8, wherein the channel comprises an FR-4 substrate.

10. An information transmission unit comprising:
a signal source;
a channel coupled to the signal source, the channel having a channel cutoff frequency;
a buffer coupled to the channel;
a continuous-time linear active filter coupled to the buffer to provide magnitude equalization between a range of frequencies above the channel cutoff frequency and a range of frequencies below the channel cutoff frequency, the continuous-time linear active filter including a differential amplifier having a single-pole transfer function; and
a sampling unit coupled to the continuous time linear active filter.

11. The information transmission unit of claim 10, wherein the channel comprises a stripline transmission line.

12. The information transmission unit of claim 11, wherein the differential amplifier comprises p-type insulated gate field-effect transistors.

13. An information transmission unit comprising:
a signal source;
a channel coupled to the signal source, the channel having a channel cutoff frequency;
a continuous-time linear active filter coupled to the channel to provide magnitude equalization, the continuous-time active filter configured as a single-ended non-inverting amplifier; and
a sampling unit coupled to the continuous time linear active filter.

14. The information transmission unit of claim 13, wherein the single-ended non-inverting amplifier comprises a one stage differential pair configuration including two p-type insulated gate field-effect transistors.

15. The information transmission unit of claim 14, wherein the single-ended non-inverting amplifier includes a single dominant pole.

16. The information transmission unit of claim 15, wherein the signal source is formed on a gallium arsenide substrate and the continuous-time linear active filer is formed on a silicon substrate.

17. The information transmission unit of claim 16, wherein the continuous time linear active filter has a cutoff frequency greater than the channel cutoff frequency.

18. An information transmission unit comprising:
a signal source;
a channel coupled to the signal source, the channel having a channel cutoff frequency;
a buffer coupled to the channel;
an active filter coupled to the buffer to provide magnitude equalization between a range of frequencies above the channel cutoff frequency and a range of frequencies below the channel cutoff frequency, the active filter including a differential amplifier having positive feedback; and
a sampling unit coupled to the active filter.

19 The information transmission unit of claim 18, wherein the signal source comprises a current driver.

20. The information transmission unit of claim 19, wherein the buffer comprises a level shifter.

21. The information transmission unit of claim 20, wherein the differential amplifier includes a non-linear load.

22. The information transmission unit of claim 18, wherein the differential amplifier comprises a differential pair cross-coupled to non-linear load.

23. The information transmission unit of claim 22, wherein the differential pair comprises two n-type insulated gate field-effect transistors.

24. The information transmission unit of claim 23, wherein the differential pair cross-coupled to the non-linear load comprises a polysilicon interconnect to provide cross-coupling.

25. An information transmission unit comprising:
a signal source;
a channel coupled to the signal source, the channel having a channel cutoff frequency;
an active filter coupled to the channel to provide magnitude equalization between a range of frequencies above the channel cutoff frequency and a range of frequencies below the channel cutoff frequency, the active filter including a differential amplifier having positive feedback; and
a sampling unit coupled to the active filter.

26. The information transmission unit of claim 25, wherein the differential amplifier includes a non-linear load.

27. The information transmission unit of claim 26, wherein the differential amplifier comprises a differential pair cross-coupled to non-linear load.

28. A method comprising:
transmitting a continuous time signal including digital information on a channel;
receiving the continuous time signal from the channel and filtering the continuous time signal to form an equalized continuous time signal; and
sampling the equalized continuous time signal to recover the digital information.

29. The method of claim 28, wherein transmitting the continuous time signal comprises transmitting the continuous time signal at a data rate of between about one billion bits per second and about five billion bits per second.

30. The method of claim 29, wherein receiving the continuous time signal from the channel comprises receiving the continuous time signal at a buffer.
